(19) United States
(12) Patent Application Publication
(10) Pub. No.: US 2020/0408716 A1
(43) Pub. Date: Dec. 31, 2020

(54) ELECTROPHORESIS ASSEMBLY

(71) Applicant: SMOBIO Technology, Inc., Hsinchu City (TW)

(72) Inventor: KUAN-LIN LEE, Hsinchu City (TW)

(73) Assignee: SMOBIO Technology, Inc., Hsinchu City (TW)

(21) Appl. No.: 16/452,478

(22) Filed: Jun. 25, 2019

(51) Int. Cl. G01N 27/447

(52) U.S. Cl. CPC G01N 27/44747

(57) ABSTRACT

This invention provided an electrophoresis assembly, comprising: a first plate; a second plate, being disposed substantially parallel to the first plate, in which a space is formed between the first plate and the second plate; a gel, being filled in the space between the first plate and the second plate; and at least one gel-support, being installed in the space at a predetermined position between the first plate and the second plate, wherein the gel-support is in tight combination with the gel for supporting the gel. The gel-support provide the gel support in the absence of the first plate or the second plate, and thus prevent a user tearing the gel when transferring the gel from a precast or other casted gel setting to other media.

### FIELD OF THE INVENTION

This invention relates to an electrophoresis assembly.

### BACKGROUND OF THE INVENTION

Western blotting is a common process used to transfer proteins from an electrophoresis matrix to a membrane for further analysis. However, the gels are often torn when they are transferred from a precast or other casted gel setting to a protein transfer membrane. Broken gel may cause bubble between gel and membrane, resulting in unclear blotting result and reading difficulties. It is hard to eliminate the gel-transfer step because the gel cartridges are made of non-conductive materials and are used to support the gels. Hence, it would be expected to develop a means so as to avoid tearing the gels during transfer.

### BRIEF SUMMARY OF THE INVENTION

This invention provided an electrophoresis assembly, comprising: a first plate; a second plate, being disposed substantially parallel to the first plate, in which a space is formed between the first plate and the second plate; a gel, being filled in the space between the first plate and the second plate; and at least one gel-support, being installed in the space at a predetermined position between the first plate and the second plate, wherein the gel-support is in tight combination with the gel for supporting the gel. The gel-support provide the gel support in the absence of the first plate or the second plate, and thus prevent a user tearing the gel when transferring the gel from a precast or other casted gel setting to other media.

### BRIEF DESCRIPTION OF THE DRAWINGS

FIG. 1a shows an exploded view of an embodiment of the electrophoresis assembly. The gel-support in this embodiment is in a shape of a triangle, wherein one corner of the triangle aligned with or close to one corner of the gel.

FIG. 1b shows a schematic perspective view of the electrophoresis assembly structure of FIG. 1a.

FIG. 2a shows an exploded view of an embodiment of the electrophoresis assembly. The gel-support in this embodiment is in a shape of a strip disposed in the horizontal manner aligned with or close to the bottom edge of the gel.

FIG. 2b shows a schematic perspective view of the electrophoresis assembly structure of FIG. 2a.

FIG. 3a shows an exploded view of an embodiment of the electrophoresis assembly. The gel-support in this embodiment comprises a first strip disposed aligned with or close to the left edge of the gel and a second strip disposed aligned with or close to the right edge of the gel.

FIG. 3b shows a schematic perspective view of the electrophoresis assembly structure of FIG. 3a.

FIG. 4a shows an exploded view of an embodiment of the electrophoresis assembly. The gel-support in this embodiment has a curve edge and a straight edge, wherein the straight edge is aligned with or close to the bottom edge of the gel.

FIG. 4b shows a schematic perspective view of the electrophoresis assembly structure of FIG. 4a.

FIG. 5a shows an exploded view of an embodiment of the electrophoresis assembly. The gel-support in this embodiment comprises a first strip disposed aligned with or close to the left edge of the gel, a second strip disposed aligned with or close to the right edge of the gel, and a third strip disposed between the first strip and the second strip in a horizontal manner and aligned with or close to the bottom edge of the gel.

FIG. 5b shows a schematic perspective view of the electrophoresis assembly structure of FIG. 5a.

FIG. 6a shows an exploded view of an embodiment of the electrophoresis assembly. The gel-support in this embodiment comprises a first strip disposed aligned with or close to the left edge of the gel and with a top side protruding out of the gel, a second strip disposed aligned with or close to the right edge of the gel, and a third strip disposed in a horizontal manner and aligned with or close to the bottom edge of the gel.

FIG. 6b shows a schematic perspective view of the electrophoresis assembly structure of FIG. 6a.

FIG. 7a shows an exploded view of an embodiment of the electrophoresis assembly. The gel-support in this embodiment comprises a first strip disposed aligned with or close to the left edge of the gel and with a top side protruding out of the gel, a second strip disposed aligned with or close to the right edge of the gel and with a top side protruding out of the gel, and a third strip disposed in a horizontal manner and aligned with or close to the bottom edge of the gel.

FIG. 7b shows a schematic perspective view of the electrophoresis assembly structure of FIG. 7a.

FIG. 8a shows an exploded view of an embodiment of the electrophoresis assembly. The gel-support in this embodiment comprises a first strip disposed aligned with or close to the left edge of the gel and with a top side with a through hole protruding out of the gel, a second strip disposed aligned with or close to the right edge of the gel and with a top side with a through hole protruding out of the gel, and a third strip disposed in a horizontal manner and aligned with or close to the bottom edge of the gel.

FIG. 8b shows a schematic perspective view of the electrophoresis assembly structure of FIG. 8a.

FIG. 9a shows an exploded view of an embodiment of the electrophoresis assembly. The gel-support in this embodiment comprises a first strip disposed aligned with or close to the left edge of the gel and with a top side forming a hook and protruding out of the gel, a second strip disposed aligned with or close to the right edge of the gel and with a top side forming a hook and protruding out of the gel, and a third strip disposed between the said strips in a horizontal manner and aligned with or close to the bottom edge of the gel.

FIG. 9b shows a schematic perspective view of the electrophoresis assembly structure of FIG. 9a.

FIG. 10a shows an exploded view of an embodiment of the electrophoresis assembly. The gel-support in this embodiment is frame shape.

FIG. 10b shows a schematic perspective view of the electrophoresis assembly structure of FIG. 10a. The upper side of the frame is disposed not to cover the comb.

FIG. 10c shows a schematic perspective view of the electrophoresis assembly. The gel-support in this embodiment is frame shape and the upper side of the frame is disposed partly cover the comb.

FIG. 10d shows a schematic perspective view of the electrophoresis assembly. The gel-support in this embodiment is frame shape and the upper side of the frame is disposed cover the comb.

FIG. 11a shows an exploded view of an embodiment of the electrophoresis assembly. The gel-support in this embodiment is substantially in a shape of rectangle with an oval shape hollow area.

FIG. 11b shows a schematic perspective view of the electrophoresis assembly structure of FIG. 11a.

FIG. 12a shows an exploded view of an embodiment of the electrophoresis assembly. The gel-support in this embodiment is substantially in a shape of rectangle with a rounded rectangle shape hollow area.

FIG. 12b shows a schematic perspective view of the electrophoresis assembly structure of FIG. 12a.

FIG. 13a shows an exploded view of an embodiment of the electrophoresis assembly. The gel-support in this embodiment comprises strips disposed in a vertical manner.

FIG. 13b shows a schematic perspective view of the electrophoresis assembly structure of FIG. 13a.

FIG. 14a shows an exploded view of an embodiment of the electrophoresis assembly. The gel-support in this embodiment comprises first strips disposed in a vertical manner, and a second strip in a horizontal manner aligned with or close to the bottom edge of the gel. In this embodiment, the first strips disposed in the vertical manner is in a position not obstructing the sample migration.

FIG. 14b shows a schematic perspective view of the electrophoresis assembly structure of FIG. 14a.

FIG. 15a shows an exploded view of an embodiment of the electrophoresis assembly. The gel-support in this embodiment comprises a first strip disposed aligned with or close to the left edge of the gel and with a top side protruding out of the gel, a second strip disposed aligned with or close to the right edge of the gel and with a top side protruding out of the gel, and a third strip disposed aligned with or close to the bottom edge of the gel and with two ends protruding out of the first plate and the second plate. Each of the strips is with one hook on the protruding part.

FIG. 15b shows a schematic perspective view of the electrophoresis assembly structure of FIG. 15a.

FIG. 16a shows an exploded view of an embodiment of the electrophoresis assembly. The gel-support in this embodiment is on frame shape and with left and right sides protruding out of the first plate and the second plate. Each of the side protruding out of the first plate and the second plate is with two hook on the protruding part.

FIG. 16b shows a schematic perspective view of the electrophoresis assembly structure of FIG. 16a.

FIG. 17 shows embodiments of the gel-support.

FIG. 18 shows a sectional view of the sample well region of the electrophoresis assembly 10 of the electrophoresis assembly 10 structure of embodiments which the gel-support 14 covering the comb 15.

FIG. 19 shows a sectional view of the sample well region of the electrophoresis assembly 10 of the electrophoresis assembly 10 structure of embodiments which the gel-support 14 covering the comb 15.

FIG. 20 shows a sectional view of the sample well region of the electrophoresis assembly 10 of the electrophoresis assembly 10 structure of embodiments which the gel-support 14 covering the comb 15.

FIG. 21 shows a sectional view of the sample well region of the electrophoresis assembly 10 of the electrophoresis assembly 10 structure of embodiments which the gel-support 14 covering the comb 15.

FIG. 22 shows a sectional view of the sample well region of the electrophoresis assembly 10 of the electrophoresis assembly 10 structure of embodiments which the gel-support 14 covering the comb 15.

### DETAILED DESCRIPTION OF THE INVENTION

This invention relates to an electrophoresis assembly, comprising: a first plate; a second plate, being disposed substantially parallel to the first plate, in which a space is formed between the first plate and the second plate; a gel, being filled in the space between the first plate and the second plate; and at least one gel-support, being installed in the space at a predetermined position between the first plate and the second plate, wherein the gel-support is in tight combination with the gel for supporting the gel.

The gel-support provide the gel support in the absence of the first plate or the second plate, and thus prevent a user tearing the gel when transferring the gel from a precast or other casted gel setting to other media.

In one embodiment, the gel-support is substantially a sheet. In another embodiment, the gel-support is substantially in a shape of a polygon. In another embodiment, the gel-support is substantially in a shape of a triangle. In another embodiment, the gel-support is substantially in a shape of a rectangle. In another embodiment, the gel-support has at least one hollow area.

In one embodiment, the gel-support is substantially in a shape of a strip.

In one embodiment, the gel-support is substantially in a shape of a wire.

In one embodiment, the gel-support comprises at least one corner which aligned with or close to one corner of the gel.

In one embodiment, the gel-support is with one edge partly or fully aligned with or close to one edge of the gel.

In one embodiment, the gel-support installed between the first plate and the second plate before filling the gel.

In one embodiment, the gel-support installed between the first plate and the second plate before the gel polymerized.

In one embodiment, the gel-support has a thickness not thicker than the gel.

In one embodiment, the gel-support is protruding out of the gel.

In one embodiment, the gel-support is protruding out of the space between the first plate and the second plate.

In one embodiment, the gel-support has at least one through hole.

In one embodiment, the gel-support has at least one hook.

In one embodiment, the gel-support can be or not be migrated through by a sample.

In another embodiment, the gel-support not be migrated through by a sample is disposed in a position not obstructing the sample migration.

In one embodiment, the gel-support is composed of porous material or polymeric substance. In another embodiment, the gel infiltrates into the gel-support.

In one embodiment, the gel-support is surface modified.

In one embodiment, the gel-support and the gel form tightly combination through forming chemical bond.

The gel-support can be composed of porous material comprising but not limit to cellulose including fibers including cotton, linen and other plant fibers, paper products including paper, paperboard and card stock, or cellulose derivatives including microcrystalline cellulose.

The gel-support can also be composed of polymeric substance comprising but not limit to cotton clothes, nylon or polyester clothes, nonwoven fabric, cellulose paper, nitrocellulose or PVDF membranes, PP, PE, PS, AS, PVC, ABS, or acrylic.

The gel-support can be surface modified by scrubbing, acid etching, coating with radiation or thermal initiative free radical polymerization, coating with silane condensation, coating with epoxy polymerization, or coating with paint.

The gel-support can be migrated through by a sample can be composed of material comprising but not limit to cellulose paper, clothes, nonwoven fabric, nitrocellulose or PVDF membrane.

The gel-support cannot be migrated through by a sample can be composed of material comprising but not limit to non-porous plastic thin layer, like PP, PE, PS, AS, PVC, ABS, or acrylic layer.

### DESCRIPTION OF EMBODIMENTS

### Examples

This invention relates to an electrophoresis assembly, comprising: a first plate; a second plate disposed substantially parallel to the first plate and forming a space between the first plate and the second plate; a gel filling the space between the first plate and the second plate; and a gel-support installed in the space between the first plate and the second plate, wherein the gel-support is in tight combination with the gel.

The examples below are non-limiting and are merely representative of various aspects and features of the present invention.

### Example 1

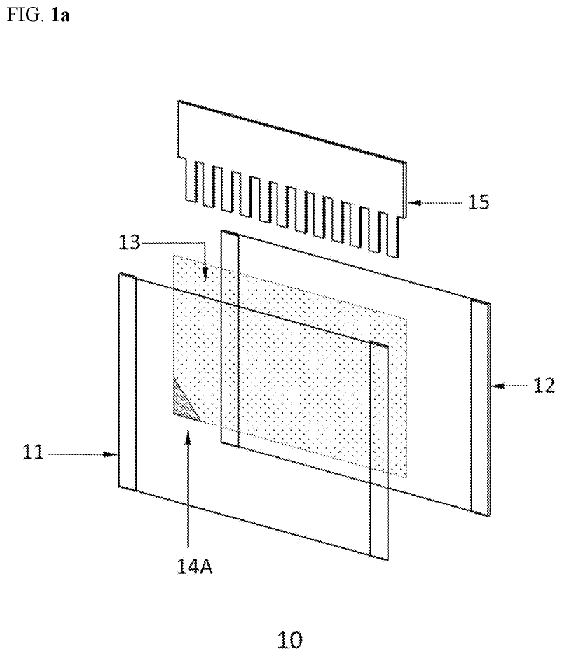

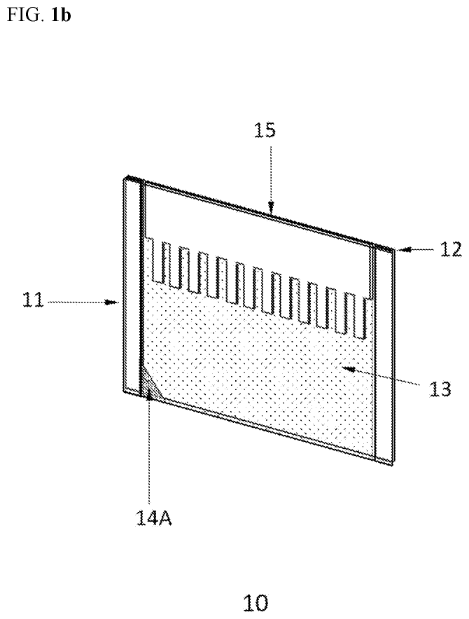

FIG. 1a shows an exploded view of an embodiment of the electrophoresis assembly 10, and FIG. 1b shows a schematic perspective view of the electrophoresis assembly 10 of FIG. 1a. The components shown in FIG. 1a is used for casting a gel to create an electrophoresis assembly 10. In the electrophoresis assembly 10, the gel 13 is filled in a space formed by the parallel-disposed first plate 11 and second plate 12. Sample loading wells is formed by a comb 15. The gel 13 is tightly combined to a gel-support 14A. As shown in FIGS. 1a and 1b, the gel-support 14A in this embodiment comprises a triangle, wherein one corner of the triangle aligned with or close to one corner of the gel 13. The gel-support 14A could be installed before filling the gel 13, or before the gel 13 polymerized. The gel-support 14A could be composed of porous material or polymeric substance. The gel-support 14A could further be surface modified. The gel-support 14A formed tightly combination with the gel 13 through infiltrated by the gel 13, or forming chemical bond with the gel 13.

### Example 2

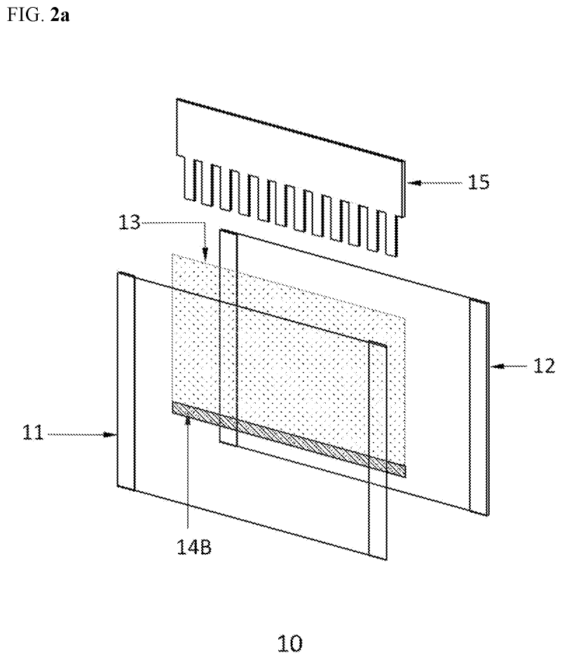

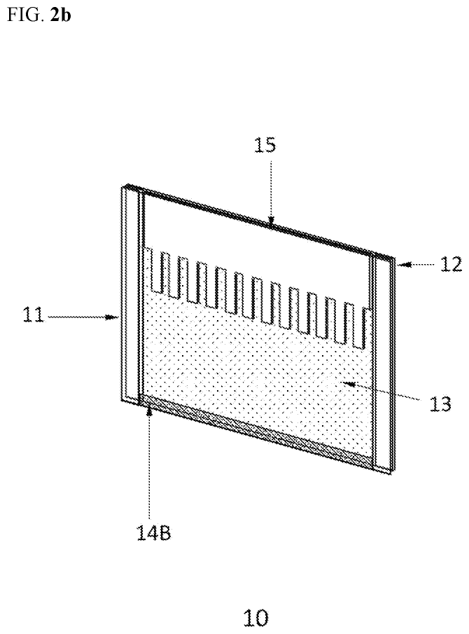

FIG. 2a shows an exploded view of an embodiment of the electrophoresis assembly 10, and FIG. 2b shows a schematic perspective view of the electrophoresis assembly 10 of FIG. 2a. The components shown in FIG. 1 is used for casting a gel to create an electrophoresis assembly 10. In the electrophoresis assembly 10, the gel 13 is filled in a space formed by the parallel-disposed first plate 11 and second plate 12. Sample loading wells is formed by a comb 15. The gel 13 is tightly combined to a gel-support 14B. As shown in FIGS. 2a and 2b, the gel-support 14B in this embodiment is in a shape of a strip disposed in the horizontal manner aligned with or close to the bottom edge of the gel 13. The gel-support 14B could be installed before filling the gel 13, or before the gel 13 polymerized. The gel-support 14B could be composed of porous material or polymeric substance. The gel-support 14B could further be surface modified. The gel-support 14B formed tightly combination with the gel 13 through infiltrated by the gel 13, or forming chemical bond with the gel 13.

### Example 3

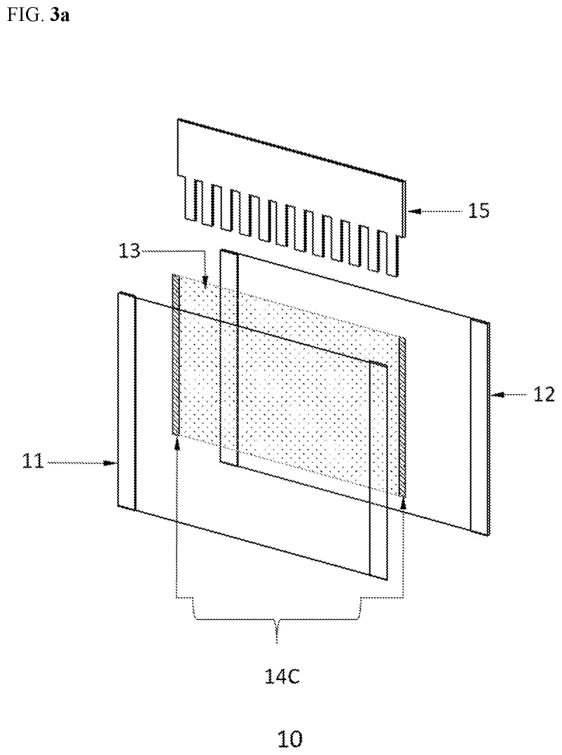

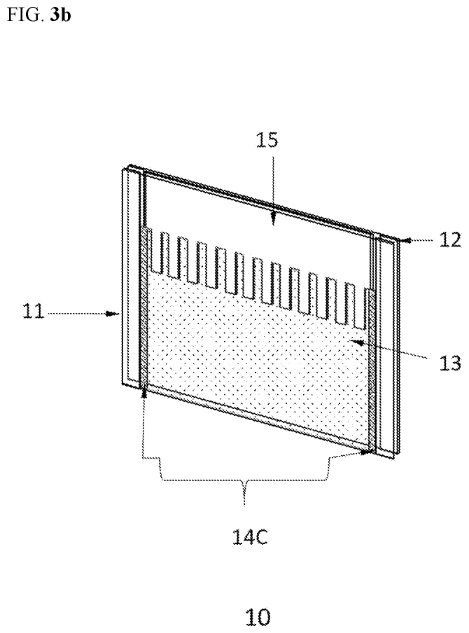

FIG. 3a shows an exploded view of an embodiment of the electrophoresis assembly 10, and FIG. 3b shows a schematic perspective view of the electrophoresis assembly 10 of FIG. 3a. The components shown in FIG. 3a is used for casting a gel to create an electrophoresis assembly 10. In the electrophoresis assembly 10, the gel 13 is filled in a space formed by the parallel-disposed first plate 11 and second plate 12. Sample loading wells is formed by a comb 15. The gel 13 is tightly combined to a gel-support 14C. As shown in FIGS. 3a and 3b, the gel-support 14C in this embodiment comprises a first strip disposed aligned with or close to the left edge of the gel 13 and a second strip disposed aligned with or close to the right edge of the gel 13. The gel-support 14C could be installed before filling the gel 13, or before the gel 13 polymerized. The gel-support 14C could be composed of porous material or polymeric substance. The gel-support 14C could further be surface modified. The gel-support 14C formed tightly combination with the gel 13 through infiltrated by the gel 13, or forming chemical bond with the gel 13.

### Example 4

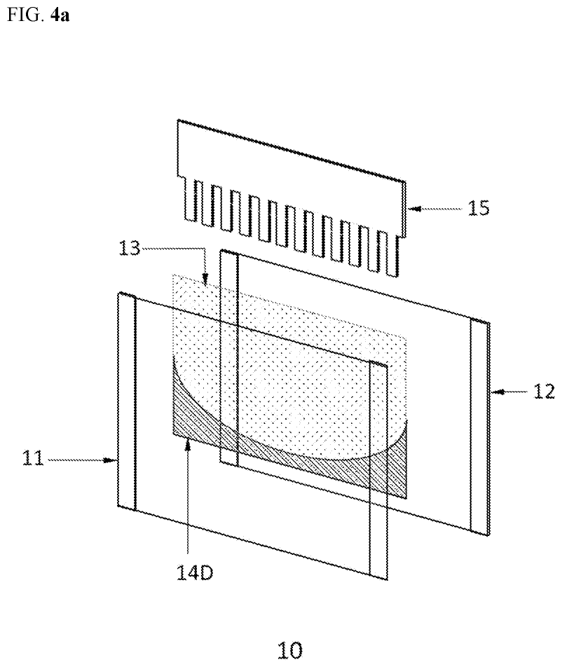

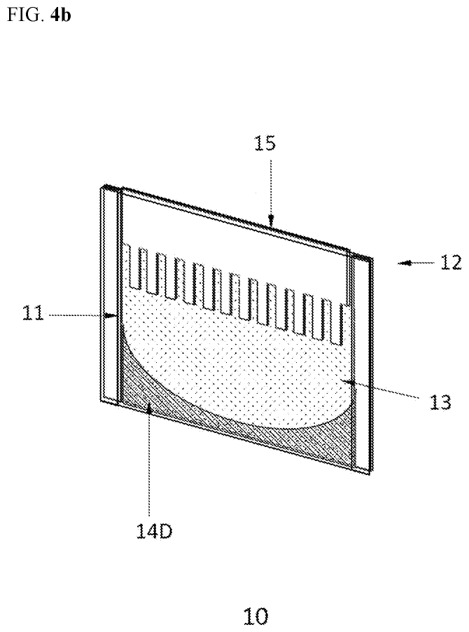

FIG. 4a shows an exploded view of an embodiment of the electrophoresis assembly 10, and FIG. 4b shows a schematic perspective view of the electrophoresis assembly 10 of FIG. 4a. The components shown in FIG. 4a is used for casting a gel to create an electrophoresis assembly 10. In the electrophoresis assembly 10, the gel 13 is filled in a space formed by the parallel-disposed first plate 11 and second plate 12. Sample loading wells is formed by a comb 15. The gel 13 is tightly combined to a gel-support 14D. As shown in FIGS. 4a and 4b, the gel-support 14D in this embodiment has a curve edge and a straight edge, wherein the straight edge is aligned with or close to the bottom edge of the gel 13. The gel-support 14D could be installed before filling the gel 13, or before the gel 13 polymerized. The gel-support 14D could be composed of porous material or polymeric substance. The gel-support 14D could further be surface modified. The gel-support 14D formed tightly combination with the gel 13 through infiltrated by the gel 13, or forming chemical bond with the gel 13.

### Example 5

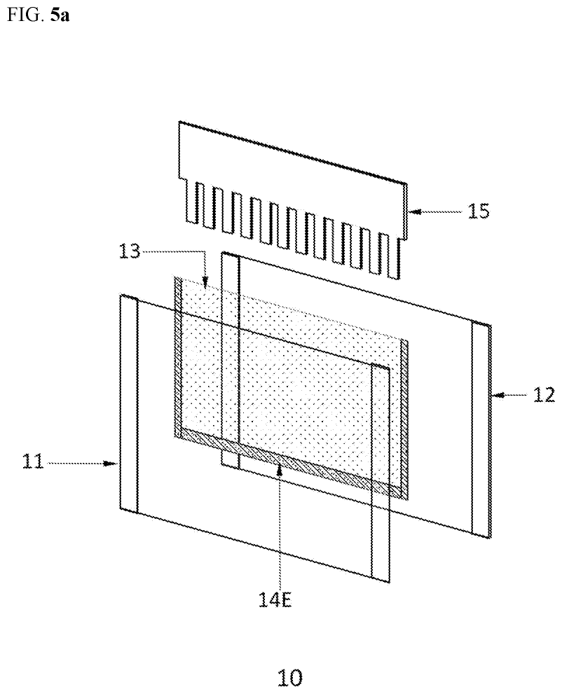

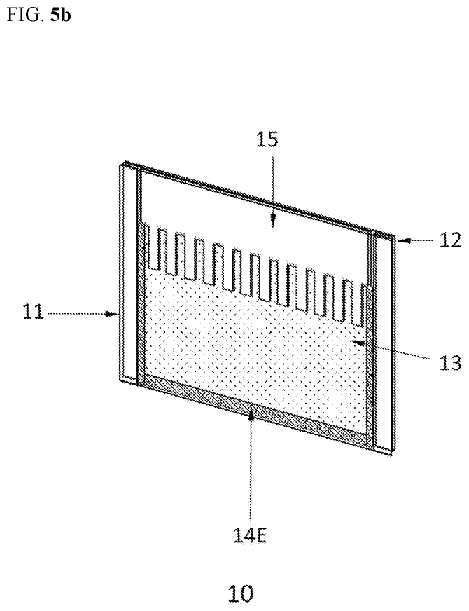

FIG. 5a shows an exploded view of an embodiment of the electrophoresis assembly 10, and FIG. 5b shows a schematic perspective view of the electrophoresis assembly 10 of FIG. 5a. The components shown in FIG. 5a is used for casting a gel to create an electrophoresis assembly 10. In the electrophoresis assembly 10, the gel 13 is filled in a space formed by the parallel-disposed first plate 11 and second plate 12. Sample loading wells is formed by a comb 15. The gel 13 is tightly combined to a gel-support 14E. As shown in FIGS. 5a and 5b, the gel-support 14E in this embodiment comprises a first strip disposed aligned with or close to the left edge of the gel 13, a second strip disposed aligned with or close to the right edge of the gel 13, and a third strip disposed between the two said strip in a horizontal manner and aligned with or close to the bottom edge of the gel 13. The gel-support 14E could be installed before filling the gel 13, or before the gel 13 polymerized. The gel-support 14E could be composed of porous material or polymeric substance. The gel-support 14E could further be surface modified. The gel-support 14E formed tightly combination with the gel 13 through infiltrated by the gel 13, or forming chemical bond with the gel 13.

### Example 6

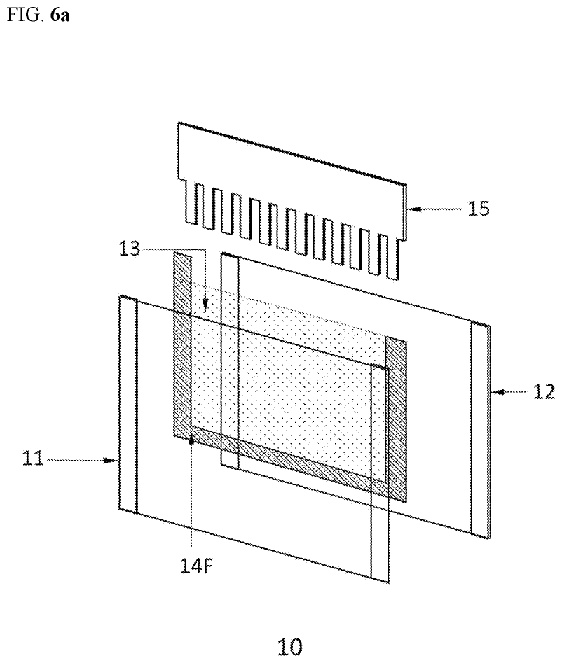

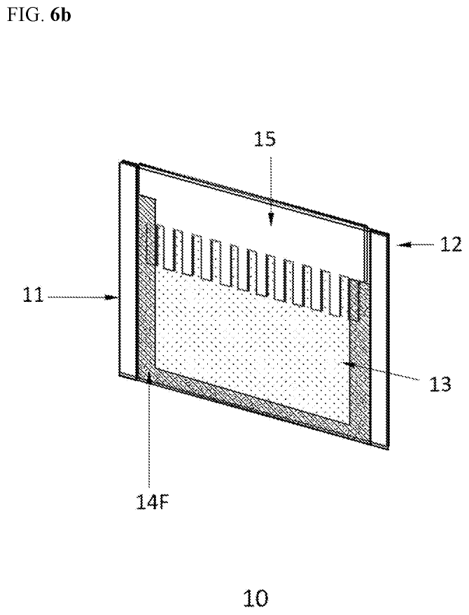

FIG. 6a shows an exploded view of an embodiment of the electrophoresis assembly 10, and FIG. 6b shows a schematic perspective view of the electrophoresis assembly 10 of FIG. 6a. The components shown in FIG. 6a is used for casting a gel to create an electrophoresis assembly 10. In the electrophoresis assembly 10, the gel 13 is filled in a space formed by the parallel-disposed first plate 11 and second plate 12. Sample loading wells is formed by a comb 15. The gel 13 is tightly combined to a gel-support 14F. As shown in FIGS. 6a and 6b, the gel-support 14F in this embodiment comprises a first strip disposed aligned with or close to the left edge of the gel 13 and with a top side protruding out of the gel 13, a second strip disposed aligned with or close to the right edge of the gel 13, and a third strip disposed in a horizontal manner and aligned with or close to the bottom edge of the gel 13. The gel-support 14F could be installed before filling the gel 13, or before the gel 13 polymerized. The gel-support 14F could be composed of porous material or polymeric substance. The gel-support 14F could further be surface modified. The gel-support 14F formed tightly combination with the gel 13 through infiltrated by the gel 13, or forming chemical bond with the gel 13.

### Example 7

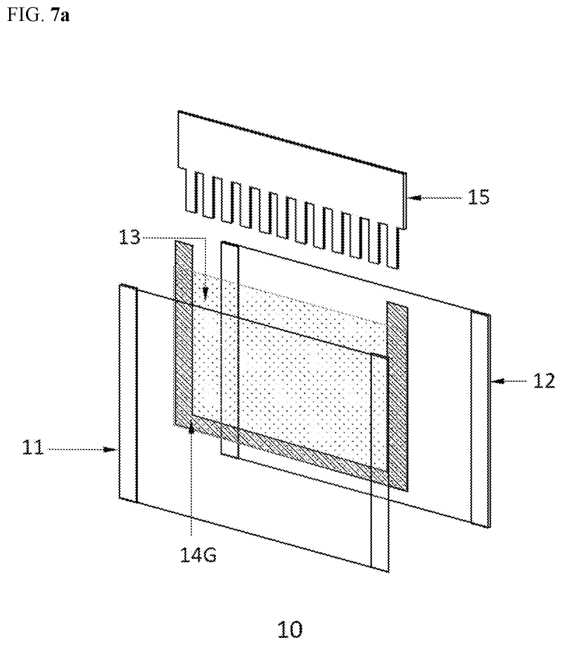

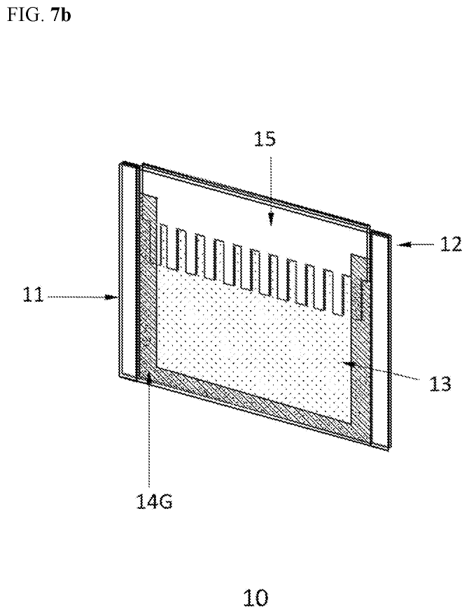

FIG. 7a shows an exploded view of an embodiment of the electrophoresis assembly 10, and FIG. 7b shows a schematic perspective view of the electrophoresis assembly 10 of FIG. 7a. The components shown in FIG. 7a is used for casting a gel to create an electrophoresis assembly 10. In the electrophoresis assembly 10, the gel 13 is filled in a space formed by the parallel-disposed first plate 11 and second plate 12. Sample loading wells is formed by a comb 15. The gel 13 is tightly combined to a gel-support 14G. As shown in FIGS. 7a and 7b, the gel-support 14G in this embodiment comprises a first strip disposed aligned with or close to the left edge of the gel 13 and with a top side protruding out of the gel 13, a second strip disposed aligned with or close to the right edge of the gel 13 and with a top side protruding out of the gel 13, and a third strip disposed in a horizontal manner and aligned with or close to the bottom edge of the gel 13. The gel-support 14G could be installed before filling the gel 13, or before the gel 13 polymerized. The gel-support 14G could be composed of porous material or polymeric substance. The gel-support 14G could further be surface modified. The gel-support 14G formed tightly combination with the gel 13 through infiltrated by the gel 13, or forming chemical bond with the gel 13.

### Example 8

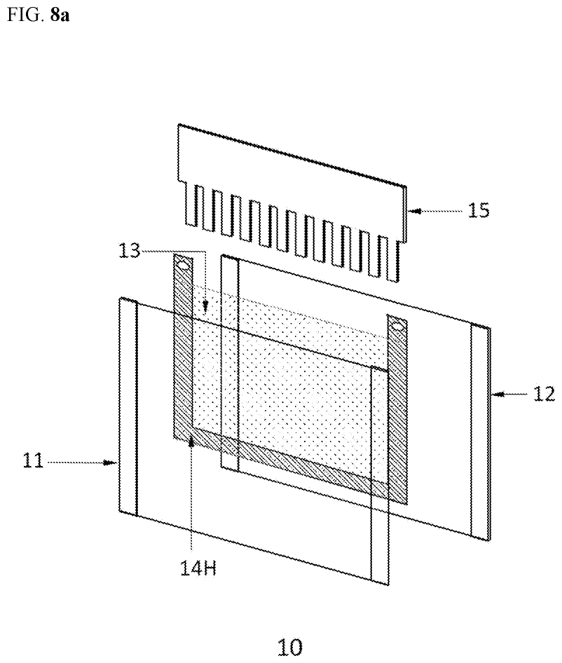

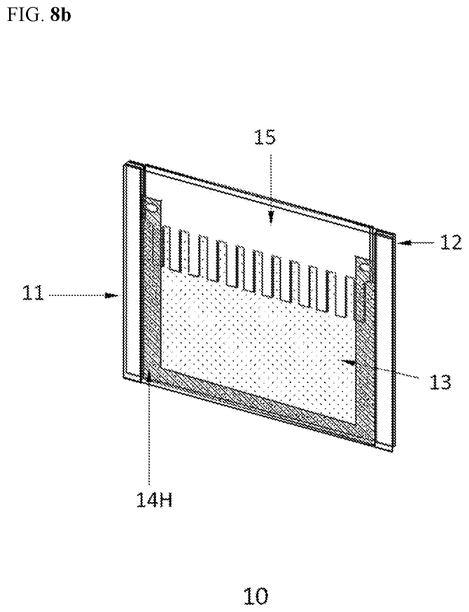

FIG. 8a shows an exploded view of an embodiment of the electrophoresis assembly 10, and FIG. 8b shows a schematic perspective view of the electrophoresis assembly 10 of FIG. 5a. The components shown in FIG. 8a is used for casting a gel to create an electrophoresis assembly 10. In the electrophoresis assembly 10, the gel 13 is filled in a space formed by the parallel-disposed first plate 11 and second plate 12. Sample loading wells is formed by a comb 15. The gel 13 is tightly combined to a gel-support 1411. As shown in FIGS. 8a and 8b, the gel 13 support 1411 in this embodiment comprises a first strip disposed aligned with or close to the left edge of the gel 13 and with a top side with a through hole protruding out of the gel 13, a second strip disposed aligned with or close to the right edge of the gel and with a top side with a through hole protruding out of the gel 13, and a third strip disposed in a horizontal manner and aligned with or close to the bottom edge of the gel 13. The gel-support 1411 could be installed before filling the gel 13, or before the gel 13 polymerized. The gel-support 1411 could be composed of porous material or polymeric substance. The gel-support 1411 could further be surface modified. The gel-support 1411 formed tightly combination with the gel 13 through infiltrated by the gel 13, or forming chemical bond with the gel 13.

### Example 9

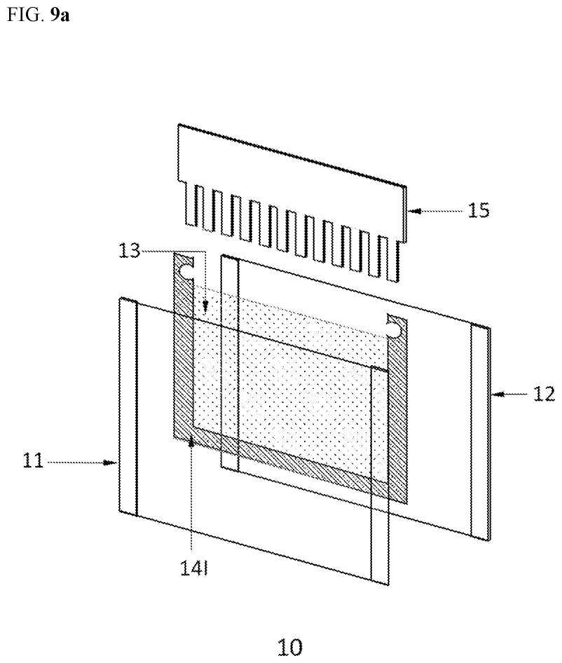

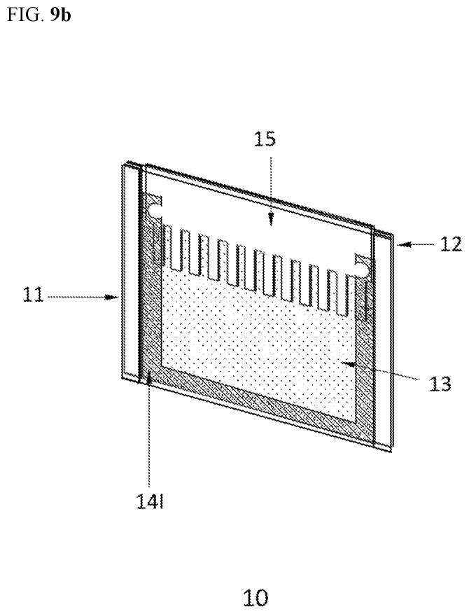

FIG. 9a shows an exploded view of an embodiment of the electrophoresis assembly 10, and FIG. 9b shows a schematic perspective view of the electrophoresis assembly 10 of FIG. 9a. The components shown in FIG. 9a is used for casting a gel to create an electrophoresis assembly 10. In the electrophoresis assembly 10, the gel 13 is filled in a space formed by the parallel-disposed first plate 11 and second plate 12. Sample loading wells is formed by a comb 15. The gel 13 is tightly combined to a gel-support 14I. As shown in FIGS. 9a and 9b, the gel-support 14I in this embodiment comprises a first strip disposed aligned with or close to the left edge of the gel 13 and with a top side forming a hook and protruding out of the gel 13, a second strip disposed aligned with or close to the right edge of the gel 13 and with a top side forming a hook and protruding out of the gel 13, and a third strip disposed in a horizontal manner and aligned with or close to the bottom edge of the gel 13. The gel-support 14I could be installed before filling the gel 13, or before the gel 13 polymerized. The gel-support 14I could be composed of porous material or polymeric substance. The gel-support 14I could further be surface modified. The gel-support 14I formed tightly combination with the gel 13 through infiltrated by the gel 13, or forming chemical bond with the gel 13.

### Example 10

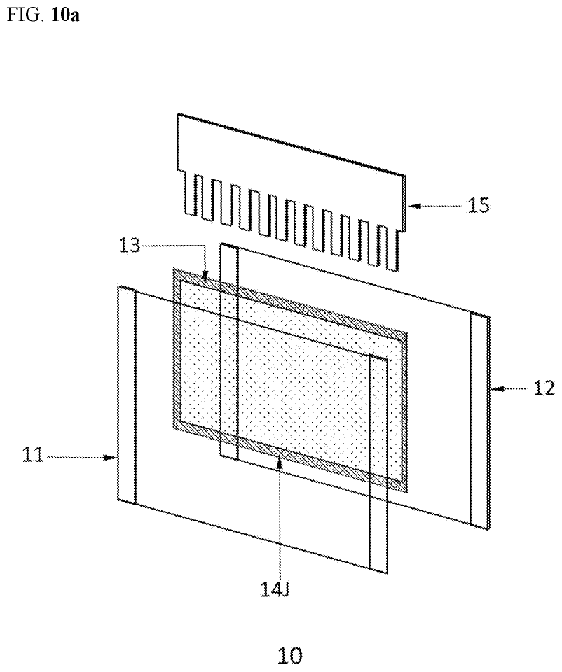

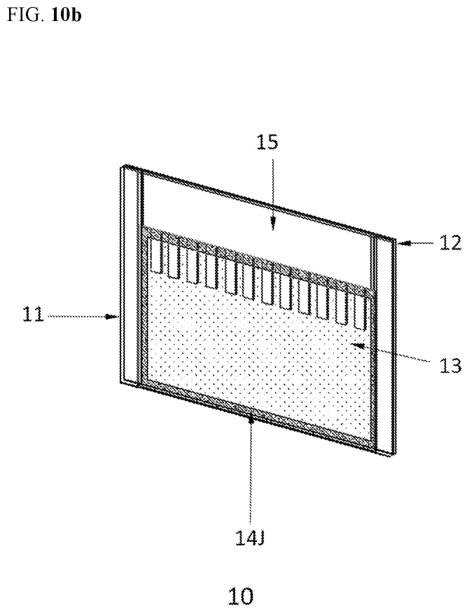

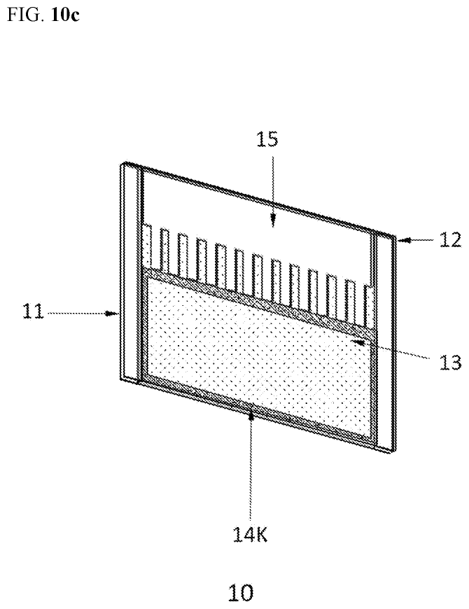

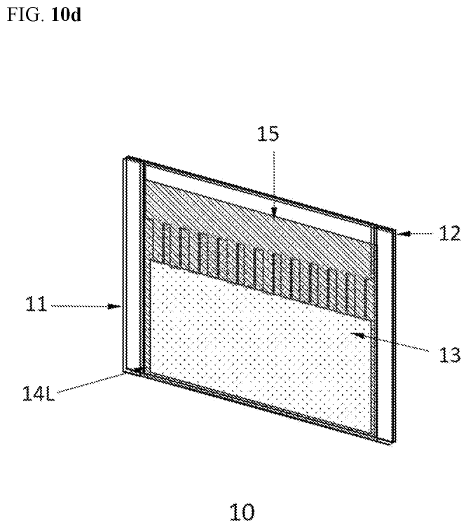

FIG. 10a shows an exploded view of an embodiment of the electrophoresis assembly 10 The components shown in FIG. 10a is used for casting a gel to create an electrophoresis assembly 10. In the electrophoresis assembly 10, the gel 13 is filled in a space formed by the parallel-disposed first plate 11 and second plate 12. Sample loading wells is formed by a comb 15. The gel 13 is tightly combined to a gel-support 14J. As shown in FIGS. 10a and 10b, the gel-support 14J in this embodiment is frame shape. FIG. 10b shows a schematic perspective view of the electrophoresis assembly 10 structure of FIG. 10a. The upper side of the frame is disposed not to cover the comb 15. A gel-support 14K in frame shape can be disposed with the upper side of the frame partly covering the comb 15 (FIG. 10c). A gel-support 14L in frame shape can also be disposed with the upper side of the frame covering the comb 15 (FIG. 10d).

### Example 11

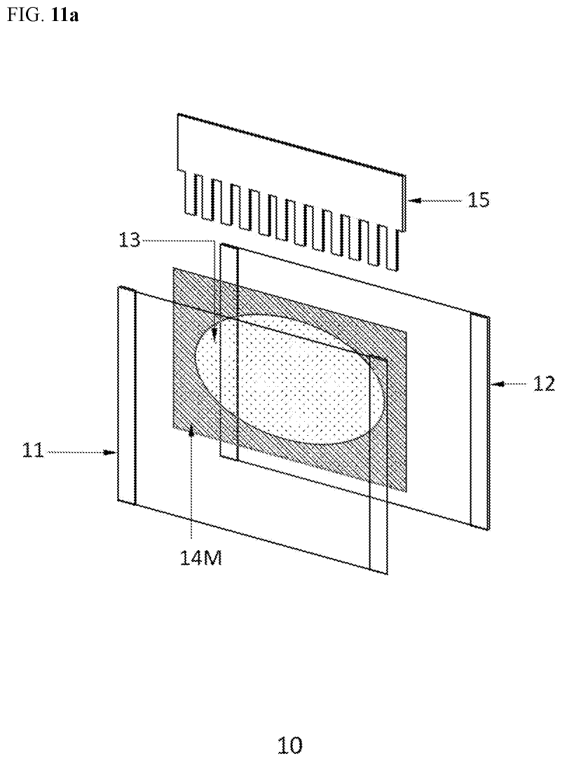

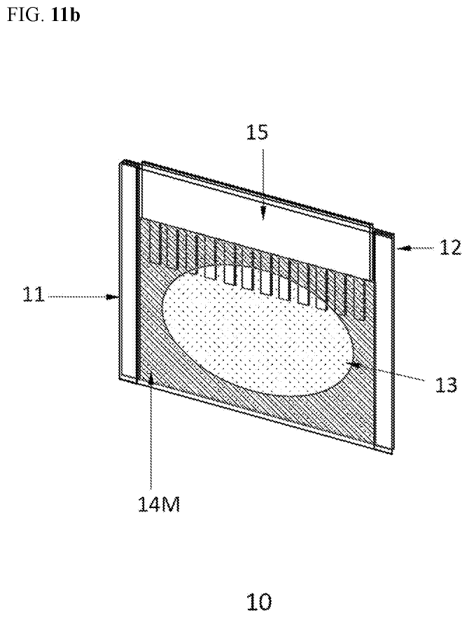

FIG. 11a shows an exploded view of an embodiment of the electrophoresis assembly 10, and FIG. 11b shows a schematic perspective view of the electrophoresis assembly 10 of FIG. 11a. The components shown in FIG. 11a is used for casting a gel to create an electrophoresis assembly 10. In the electrophoresis assembly 10, the gel 13 is filled in a space formed by the parallel-disposed first plate 11 and second plate 12. Sample loading wells is formed by a comb 15. The gel 13 is tightly combined to a gel-support 14M. As shown in FIGS. 11a and 11b, the gel-support 14M in this embodiment is substantially in a shape of rectangle with an oval shape hollow area. The gel-support 14M could be installed before filling the gel 13, or before the gel 13 polymerized. The gel-support 14M could be composed of porous material or polymeric substance. The gel-support 14M could further be surface modified. The gel-support 14M formed tightly combination with the gel 13 through infiltrated by the gel 13, or forming chemical bond with the gel 13.

### Example 12

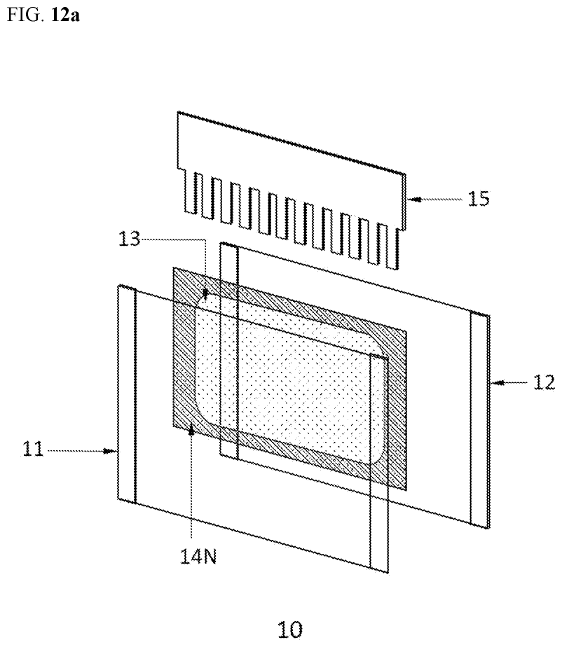

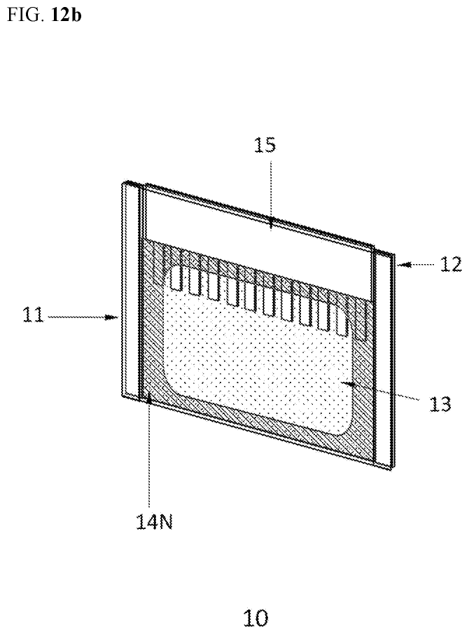

FIG. 12a shows an exploded view of an embodiment of the electrophoresis assembly 10, and FIG. 12b shows a schematic perspective view of the electrophoresis assembly 10 of FIG. 12a. The components shown in FIG. 12a is used for casting a gel to create an electrophoresis assembly 10. In the electrophoresis assembly 10, the gel 13 is filled in a space formed by the parallel-disposed first plate 11 and second plate 12. Sample loading wells is formed by a comb 15. The gel 13 is tightly combined to a gel-support 14N. As shown in FIGS. 12a and 12b, the gel-support 14N in this embodiment is substantially in a shape of rectangle with a rounded rectangle shape hollow area. The gel-support 14N could be installed before filling the gel 13, or before the gel 13 polymerized. The gel-support 14N could be composed of porous material or polymeric substance. The gel-support 14N could further be surface modified. The gel-support 14N formed tightly combination with the gel 13 through infiltrated by the gel 13, or forming chemical bond with the gel 13.

### Example 13

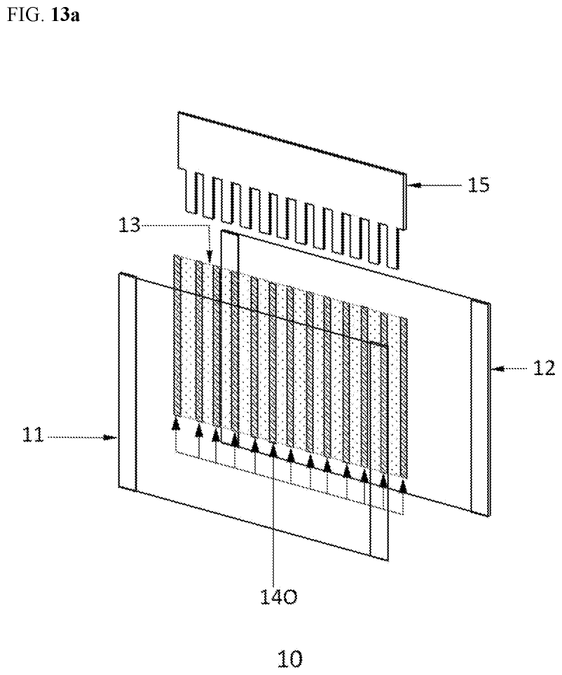

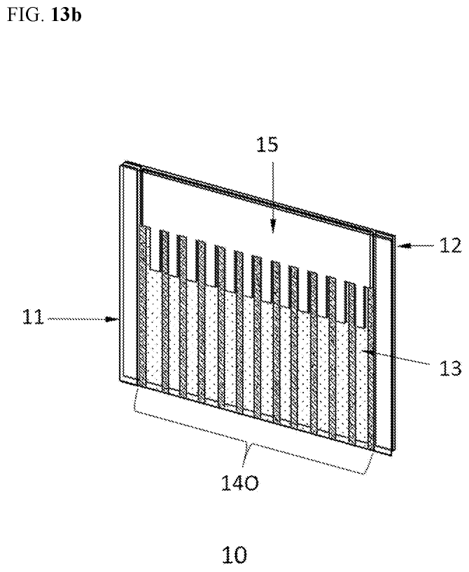

FIG. 13a shows an exploded view of an embodiment of the electrophoresis assembly 10, and FIG. 13b shows a schematic perspective view of the electrophoresis assembly 10 of FIG. 13a. The components shown in FIG. 13a is used for casting a gel to create an electrophoresis assembly 10. In the electrophoresis assembly 10, the gel 13 is filled in a space formed by the parallel-disposed first plate 11 and second plate 12. Sample loading wells is formed by a comb 15. The gel 13 is tightly combined to a gel-support 14O. As shown in FIGS. 13a and 13b, the gel-support 14O in this embodiment comprises strips disposed in a vertical manner. The gel-support 14O could be installed before filling the gel 13, or before the gel 13 polymerized. The gel-support 14O could be composed of porous material or polymeric substance. The gel-support 14O could further be surface modified. The gel-support 14O formed tightly combination with the gel 13 through infiltrated by the gel 13, or forming chemical bond with the gel 13.

### Example 14

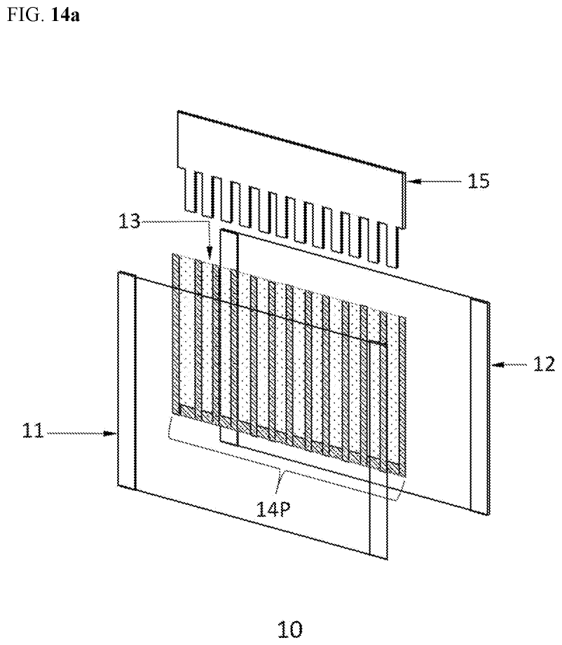

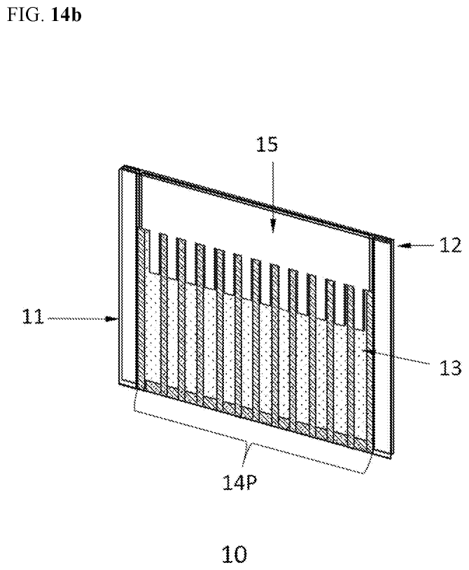

FIG. 14a shows an exploded view of an embodiment of the electrophoresis assembly 10, and FIG. 14b shows a schematic perspective view of the electrophoresis assembly 10 of FIG. 14a. The components shown in FIG. 14a is used for casting a gel to create an electrophoresis assembly 10. In the electrophoresis assembly 10, the gel 13 is filled in a space formed by the parallel-disposed first plate 11 and second plate 12. Sample loading wells is formed by a comb 15. The gel 13 is tightly combined to a gel-support 14P. As shown in FIGS. 14a and 14b, the gel-support 14P in this embodiment comprises first strips disposed in a vertical manner, and a second strip in a horizontal manner aligned with or close to the bottom edge of the gel 13. In this embodiment, the first strips disposed in the vertical manner is in a position not obstructing the sample migration. The gel-support 14P could be installed before filling the gel 13, or before the gel 13 polymerized. The gel-support 14P could be composed of porous material or polymeric substance. The gel-support 14P could further be surface modified. The gel-support 14P formed tightly combination with the gel 13 through infiltrated by the gel 13, or forming chemical bond with the gel 13.

### Example 15

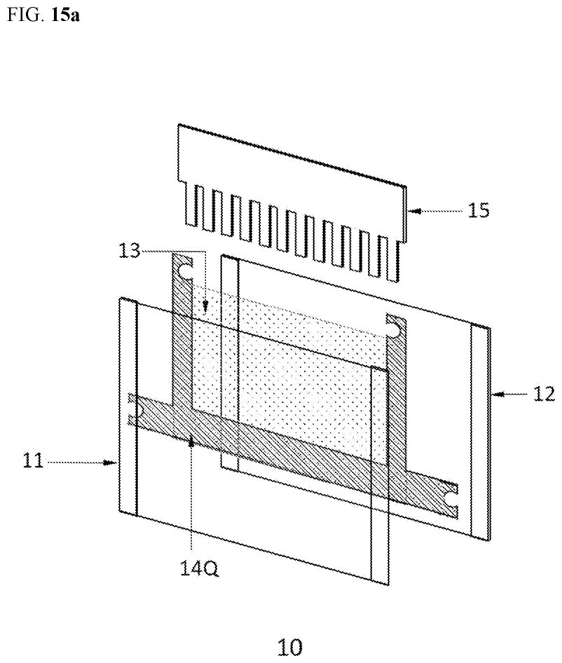

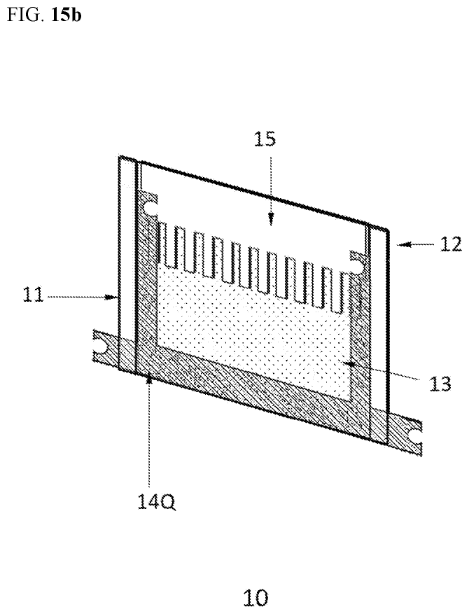

FIG. 15a shows an exploded view of an embodiment of the electrophoresis assembly 10, and FIG. 15b shows a schematic perspective view of the electrophoresis assembly 10 of FIG. 15a. The components shown in FIG. 15a is used for casting a gel to create an electrophoresis assembly 10. In the electrophoresis assembly 10, the gel 13 is filled in a space formed by the parallel-disposed first plate 11 and second plate 12. Sample loading wells is formed by a comb 15. The gel 13 is tightly combined to a gel-support 14Q. As shown in FIGS. 15a and 15b, the gel-support 14Q in this embodiment comprises a first strip disposed aligned with or close to the left edge of the gel 13 and with a top side protruding out of the gel 13, a second strip disposed aligned with or close to the right edge of the gel 13 and with a top side protruding out of the gel 13, and a third strip disposed aligned with or close to the bottom edge of the gel 13 and with two ends protruding out of the first plate 11 and the second plate 12. Each of the strips is with one hook on the protruding part. The gel-support 14Q could be installed before filling the gel 13, or before the gel 13 polymerized. The gel-support 14Q could be composed of porous material or polymeric substance. The gel-support 14Q could further be surface modified. The gel-support 14Q formed tightly combination with the gel 13 through infiltrated by the gel 13, or forming chemical bond with the gel 13.

### Example 16

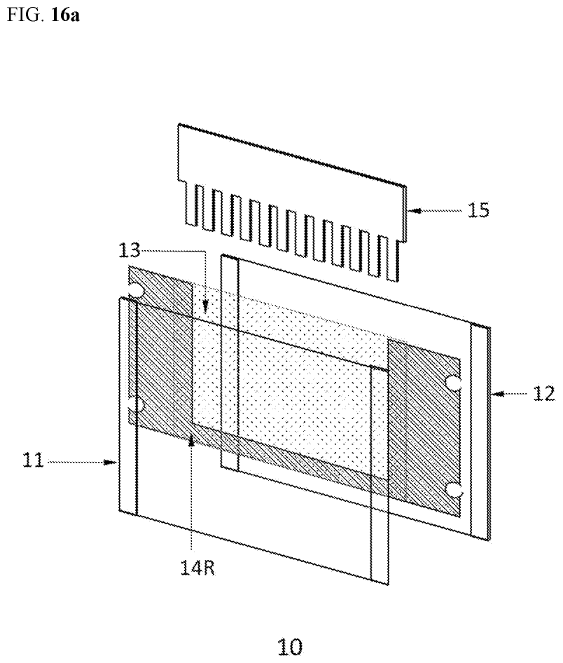

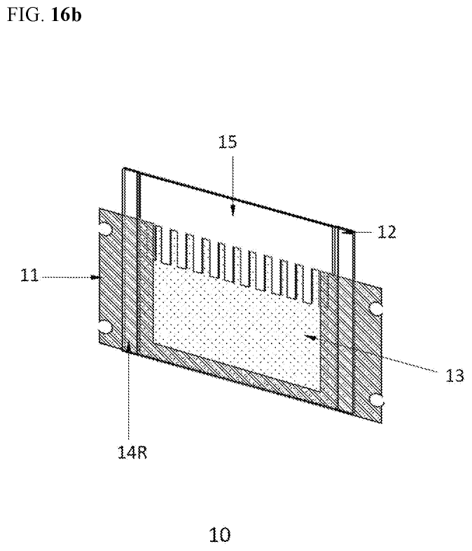

FIG. 16a shows an exploded view of an embodiment of the electrophoresis assembly 10, and FIG. 16b shows a schematic perspective view of the electrophoresis assembly 10 of FIG. 16a. The components shown in FIG. 16a is used for casting a gel to create an electrophoresis assembly 10. In the electrophoresis assembly 10, the gel 13 is filled in a space formed by the parallel-disposed first plate 11 and second plate 12. Sample loading wells is formed by a comb 15. The gel 13 is tightly combined to a gel-support 14R. As shown in FIGS. 16a and 16b, the gel-support 14R in this embodiment is on frame shape and with left and right sides protruding out of the first plate 11 and the second plate 12. Each of the side protruding out of the first plate 11 and the second plate 12 is with two hook on the protruding part. The gel-support 14R could be installed before filling the gel 13, or before the gel 13 polymerized. The gel-support 14R could be composed of porous material or polymeric substance. The gel-support 14R could further be surface modified. The gel-support 14R formed tightly combination with the gel 13 through infiltrated by the gel 13, or forming chemical bond with the gel 13.

### Example 17

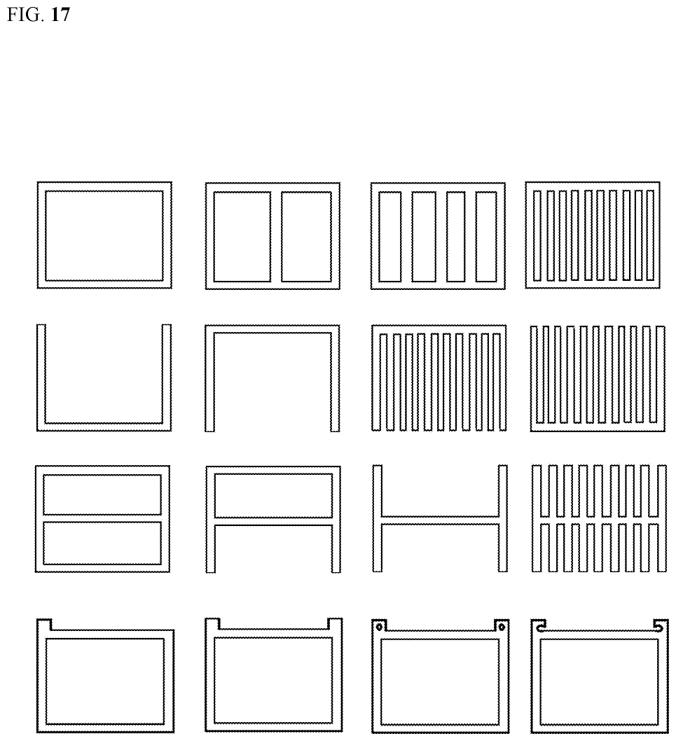

FIG. 17 shows embodiments of the gel-support. The gel-support can be or not be migrated through by a sample. The gel-support not be migrated through by a sample is disposed in a position not obstructing the sample migration, or with a thickness not obstructing the sample migration.

### Example 18

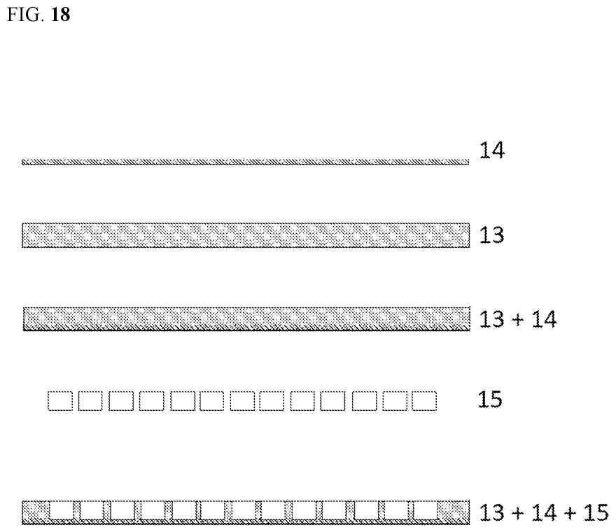

FIG. 18 shows a sectional view of the sample well region of the electrophoresis assembly 10 of the electrophoresis assembly 10 structure of embodiments which the gel-support 14 covering the comb 15. The gel-support 14 and the gel 13 are formed in a combination, and the comb 15 is inserted in the gel 13 to make sample wells. In this embodiment, the gel-support 14 is made of porous material and is infiltrated by the gel 13. The gel-support 14 could further be surface modified. The thickness of the comb 15 is thinner than the thickness of the combination of the gel 13 and the gel-support 14. The gel-support 14 could be installed before filling the gel 13, or before the gel 13 polymerized.

### Example 19

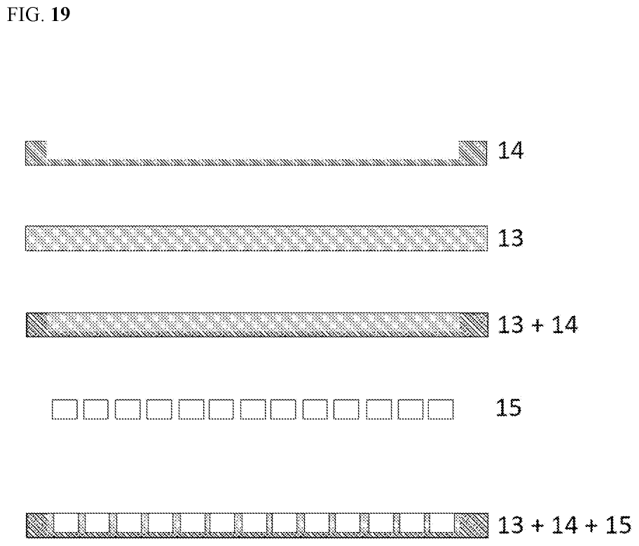

FIG. 19 shows a sectional view of the sample well region of the electrophoresis assembly 10 of the electrophoresis assembly 10 structure of embodiments which the gel-support 14 covering the comb 15. The gel-support 14 and the gel 13 are formed in a combination, and the comb 15 is inserted in the gel 13 to make sample wells. In this embodiment, the gel-support 14 is made of porous material and is infiltrated by the gel 13. The gel-support 14 could further be surface modified. The gel-support 14 shows in a thinner manner in the region that covers the comb 15. The thickness of the comb 15 is thinner than the thickness of the combination of the gel 13 and the gel-support 14. The gel-support 14 could be installed before filling the gel 13, or before the gel 13 polymerized.

### Example 20

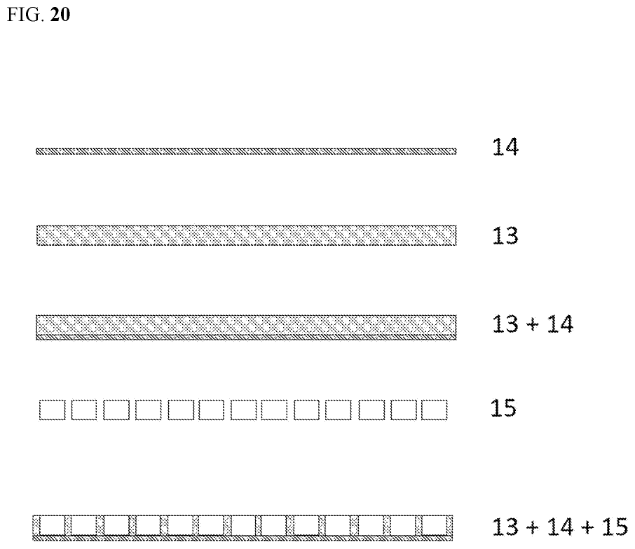

FIG. 20 shows a sectional view of the sample well region of the electrophoresis assembly 10 of the electrophoresis assembly 10 structure of embodiments which the gel-support 14 covering the comb 15. The gel-support 14 and the gel 13 are formed in a combination, and the comb 15 is inserted in the gel 13 to make sample wells. In this embodiment, the gel-support 14 is made of material that cannot be infiltrated by the gel 13. The gel-support 14 could further be surface modified. The thickness of the comb 15 is thinner than the thickness of the combination of the gel 13 and the gel-support 14. The gel-support 14 could be installed before filling the gel 13, or before the gel 13 polymerized.

### Example 21

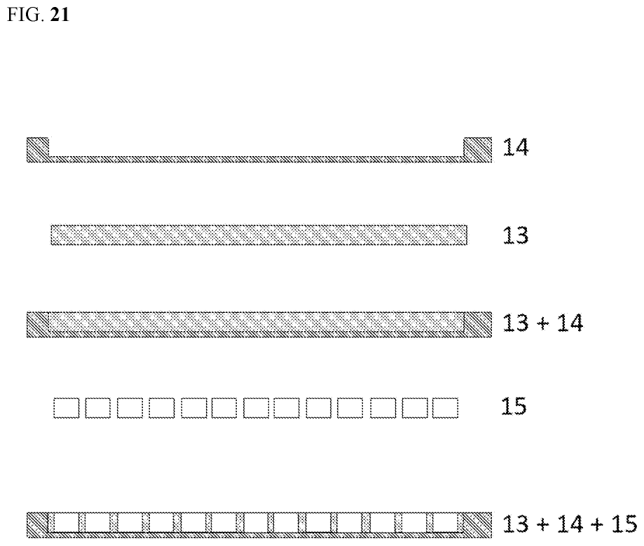

FIG. 21 shows a sectional view of the sample well region of the electrophoresis assembly 10 of the electrophoresis assembly 10 structure of embodiments which the gel-support 14 covering the comb 15. The gel-support 14 and the gel 13 are formed in a combination, and the comb 15 is inserted in the gel 13 to make sample wells. In this embodiment, the gel-support 14 is made of material that cannot be infiltrated by the gel 13. The gel-support 14 could further be surface modified. The gel-support 14 shows in a thinner manner in the region that covers the comb 15. The thickness of the comb 15 is thinner than the thickness of the combination of the gel 13 and the gel-support 14. The gel-support 14 could be installed before filling the gel 13, or before the gel 13 polymerized.

### Example 22

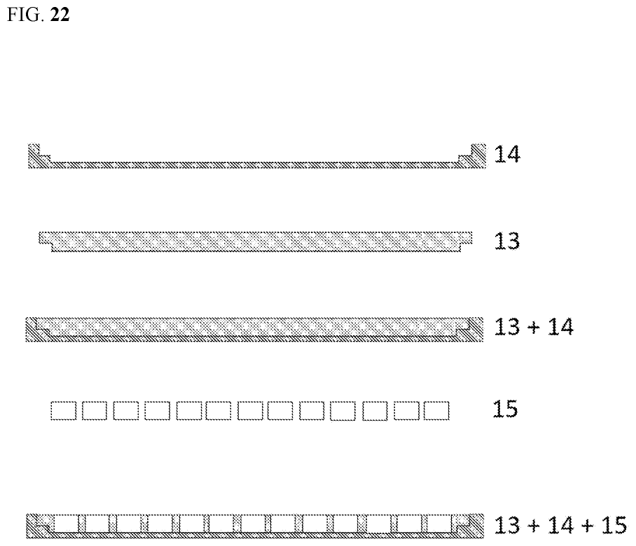

FIG. 22 shows a sectional view of the sample well region of the electrophoresis assembly 10 of the electrophoresis assembly 10 structure of embodiments which the gel-support 14 covering the comb 15. The gel-support 14 and the gel 13 are formed in a combination, and the comb 15 is inserted in the gel 13 to make sample wells. In this embodiment, the gel-support 14 is made of material that cannot be infiltrated by the gel 13. The gel-support 14 could further be surface modified. The gel-support 14 shows in a thinner manner in the region that covers the comb 15, and the left side and the right side of the gel-support 14 show in stair-like shape. The thickness of the comb 15 is thinner than the thickness of the combination of the gel 13 and the gel-support 14. The gel-support 14 could be installed before filling the gel 13, or before the gel 13 polymerized.

What is claimed is:

1. An electrophoresis assembly, comprising:
a first plate;
a second plate, being disposed substantially parallel to the first plate, in which a space is formed between the first plate and the second plate;
a gel, being filled in the space between the first plate and the second plate; and
at least one gel-support, being installed in the space at a predetermined position between the first plate and the second plate, wherein the gel-support is in tight combination with the gel for supporting the gel.

2. The electrophoresis assembly according to claim 1, wherein the gel-support is substantially a sheet.

3. The electrophoresis assembly according to claim 2, wherein the gel-support is substantially in a shape of a polygon.

4. The electrophoresis assembly according to claim 3, wherein the gel-support is substantially in a shape of a triangle.

5. The electrophoresis assembly according to claim 3, wherein the gel-support is substantially in a shape of a rectangle.

6. The electrophoresis assembly according to claim 5, wherein the gel-support has at least one hollow area.

7. The electrophoresis assembly according to claim 1, wherein the gel-support is substantially in a shape of a strip.

8. The electrophoresis assembly according to claim 1, wherein the gel-support is substantially in a shape of a wire.

9. The electrophoresis assembly according to claim 1, wherein the gel-support comprises at least one corner which aligned with or close to one corner of the gel.

10. The electrophoresis assembly according to claim 1, wherein the gel-support is with one edge partly or fully aligned with or close to one edge of the gel.

11. The electrophoresis assembly according to claim 1, wherein the gel-support installed between the first plate and the second plate before filling the gel.

12. The electrophoresis assembly according to claim 1, wherein the gel-support installed between the first plate and the second plate before the gel polymerized.

13. The electrophoresis assembly according to claim 1, wherein the gel-support has a thickness not thicker than the gel.

14. The electrophoresis assembly according to claim 1, wherein the gel-support is protruding out of the gel.

15. The electrophoresis assembly according to claim 1, wherein the gel-support is protruding out of the space between the first plate and the second plate.

16. The electrophoresis assembly according to claim 1, wherein the gel-support has at least one through hole.

17. The electrophoresis assembly according to claim 1, wherein the gel-support has at least one hook.

18. The electrophoresis assembly according to claim 1, wherein the gel-support can be or not be migrated through by a sample.

19. The electrophoresis assembly according to claim 18, wherein the gel-support not be migrated through by a sample is disposed in a position not obstructing the sample migration.

20. The electrophoresis assembly according to claim 1, wherein the gel-support is composed of porous material or polymeric substance.

21. The electrophoresis assembly according to claim 20, wherein the gel infiltrates into the gel-support.

22. The electrophoresis assembly according to claim 1, wherein the gel-support is surface modified.

23. The electrophoresis assembly according to claim 1, wherein the gel-support and the gel form tightly combination through forming chemical bond.
